(19) United States
(12) Patent Application Publication
(10) Pub. No.: US 2018/0117857 A1
(43) Pub. Date: May 3, 2018

(54) Integrally-Formed Nonwoven Object Manufacturing Method

(71) Applicants: Feng-Jung Chuang, Taichung City (TW); Wen-Yung Chang, Taichung City (TW)

(72) Inventors: Feng-Jung Chuang, Taichung City (TW); Wen-Yung Chang, Taichung City (TW)

(21) Appl. No.: 15/339,998

(22) Filed: Nov. 1, 2016

(51) Int. Cl. B29C 69/02; B29C 69/00; B29C 43/24; B29C 44/28; B29C 59/04

(52) U.S. Cl. CPC B29C 69/02; B29C 69/001; B29C 43/24; B29K 2075/00; B29C 59/046; B29C 2793/009; B29C 44/28

(57) ABSTRACT

An integrally-formed nonwoven object manufacturing method includes a raw material mixing step, a roller mixing step, a plastic sheet forming step, a foaming step, an embossing step, and a post-process step to manufacture a nonwoven object from TPU material such that the manufacturing process dispenses with a solvent to thereby effectuate environmental protection and reduce processing steps.

### BACKGROUND OF THE INVENTION

### Technical Field

The present invention relates to integrally-formed nonwoven object manufacturing methods and, more particularly, to an integrally-formed nonwoven object manufacturing method for manufacturing a nonwoven object from TPU material such that the manufacturing process dispenses with a solvent to thereby effectuate environmental protection and reduce processing steps.

### Description of Prior Art

Conventional manufacturing processes of synthetic leathers always require organic solvents. Although the organic solvents are recyclable, not only does installing recycling equipment incur high costs, but it is also difficult to achieve a 100% recycling rate. As a result, it is impossible that organic solvents are not detected in synthetic leathers. Therefore, conventional manufacturing processes of synthetic leathers do not meet green requirements. Furthermore, conventional manufacturing processes of synthetic leathers involve complicated post-processing, and the synthetic leathers thus manufactured have to be sewn and affixed with decorations, thereby rendering the manufacturing of the synthetic leathers complicated.

Conventional manufacturing methods and applications of synthetic leathers are disclosed as follows:
1. Taiwan patent application 087109330. Process: “non-vulcanized rubber base” and “EVA shoe material semi-finished product” are adhered together with toluene and a detergent, settled, heated, ripen, and re-cooled. Drawback: the aforesaid process not only requires an organic solvent which jeopardizes the environment, but is also too intricate and lengthy to be cost-efficient.
2. Taiwan patent application 094111508. Process: a trace of a cross-linking agent remains in the upper layer of rubber decorations and undergoes a cross-linking reaction with an outsole blank (EVA foaming material) to effectuate an adhering, forming process. Drawback: cross-linking agents are organic solvents and thus jeopardize the environment.

### SUMMARY OF THE INVENTION

It is an objective of the present invention to provide an integrally-formed nonwoven object manufacturing method which uses thermoplastic polyurethane (TPU) as a raw material such that the manufacturing process dispenses with a solvent so as to be environment-friendly and effectuate environmental protection.

Another objective of the present invention is to provide an integrally-formed nonwoven object manufacturing method characterized in that, during the manufacturing process, a vacuum embossing roll comes with a pattern and a texture, and a nonwoven object thus formed need not be sewn or affixed with decorations, thereby reducing processing steps.

In order to achieve the above and other objectives, the present invention provides an integrally-formed nonwoven object manufacturing method which essentially comprises a raw material mixing step, a roller mixing step, a plastic sheet forming step, a foaming step, an embossing step, and a post-process step.

In the raw material mixing step, TPU resin particles and an assistant are put in a mixer to get mixed while being heated up, thereby allowing the TPU resin particles and the assistant to melt and turn into a pellet-shaped first raw material.

In the roller mixing step, the first raw material is placed between rollers to get rolled and heated up such that the first raw material is fully mixed, thereby allowing the rolled first raw material to turn into a semi-liquefied second raw material.

In the plastic sheet forming step, the second raw material is put in a plastic sheet-forming machine, wherein the distance between rollers of the plastic sheet-forming machine is controlled to therefore control the thickness of a doughy plastic sheet product, and the plastic sheet product passes a cooling roller to get cooled and shaped before being wound onto a shaft.

In the foaming step, the wound plastic sheet product is placed on a coater and delivered into a foaming furnace to get heated to 200° C. such that it foams and expands, and then the plastic sheet product which has foamed is processed with ultraviolet (UV) to keep its temperature stable.

In the embossing step, the UV-processed foaming plastic sheet product is placed beneath a vacuum embossing roll with a concave pattern and texture and wound into the vacuum embossing roll to produce a foaming plastic sheet with the pattern and texture formed thereon by evacuation, and then the foaming plastic sheet is cooled and wound into a cylinder.

In the post-process step, the foaming plastic sheet with the pattern and texture is cut to obtain the integrally-formed nonwoven object.

The manufacturing method has advantages as follows:
1. TPU is a highly cured material with high wear resistance and high tear resistance. During its manufacturing process, TPU melts in the absence of any solvent. TPU, a plastic material, is environment-friendly and thus does not jeopardize the environment.
2. In the vacuum embossing step of the present invention, with a pattern and texture being disposed on the surface of the vacuum embossing roll, a foaming plastic sheet thus manufactured has a texture which looks like sewing stitches and has a decorative pattern. Unlike its conventional counterpart, the nonwoven object of the present invention need not be cut, sewn and affixed with decorations, thereby simplifying the processing process.
3. The integrally-formed nonwoven object manufacturing method of the present invention further comprises a screen printing step or a digital printing step whereby the nonwoven object acquires different textures and colors.

### BRIEF DESCRIPTION OF THE DRAWINGS

FIG. 1 is a manufacturing flow chart of the present invention; and

FIG. 2 is a schematic view of the use of the present invention.

### DETAILED DESCRIPTION OF THE EMBODIMENT OF THE INVENTION

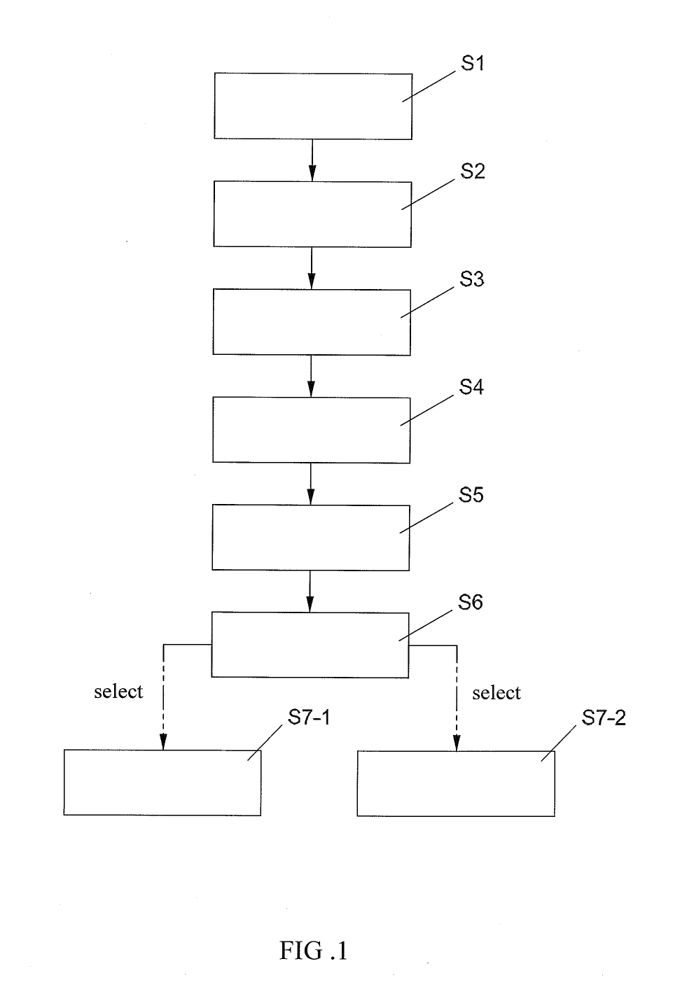

Referring to FIG. 1, an integrally-formed nonwoven object manufacturing method of the present invention essentially comprises a raw material mixing step S1, a roller mixing step S2, a plastic sheet forming step S3, a foaming step S4, an embossing step S5, and a post-process step S6.

In the raw material mixing step S1, TPU resin particles and an assistant are put in a mixer to get mixed while being heated up, thereby allowing the TPU resin particles and the assistant to melt and turn into a pellet-shaped first raw material.

In the roller mixing step S2, the first raw material is placed between rollers to get rolled and heated up such that the first raw material is fully mixed, thereby allowing the rolled first raw material to turn into a semi-liquefied second raw material.

In the plastic sheet forming step S3, the second raw material is put in a plastic sheet-forming machine, wherein the distance between rollers of the plastic sheet-forming machine is controlled to therefore control the thickness of a doughy plastic sheet product, and the plastic sheet product passes a cooling roller to get cooled and shaped before being wound onto a shaft.

In the foaming step S4, the wound plastic sheet product is placed on a coater and delivered into a foaming furnace to get heated to 200° C. such that it foams and expands, and then the plastic sheet product which has foamed is processed with ultraviolet (UV) to keep its temperature stable.

In the embossing step S5, the UV-processed foaming plastic sheet product is placed beneath a vacuum embossing roll with a concave pattern and texture and wound into the vacuum embossing roll to produce a foaming plastic sheet with the pattern and texture formed thereon by evacuation, and then the foaming plastic sheet is cooled and wound into a cylinder.

In the post-process step S6, the foaming plastic sheet with the pattern and texture is cut to obtain the integrally-formed nonwoven object.

According to the present invention, the post-process step S6 is followed by one of the two steps described below.

The screen printing step S7-1: the integrally-formed nonwoven object is fitted onto a screen and coated with colors and textures such that the nonwoven object acquires different colors and textures.

The digital printing step S7-2: the integrally-formed nonwoven object is placed on a digital printer and coated with colors and textures such that the nonwoven object acquires different colors and textures.

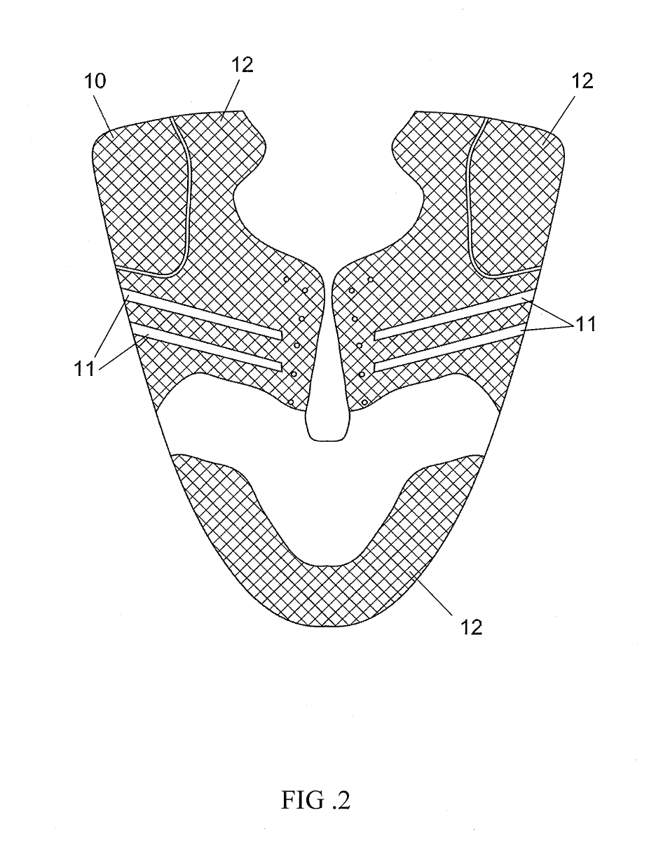

With reference to the aforesaid manufacturing steps, the applications and advantages of the present invention are as follows:
1. Referring to FIGS. 1, 2, the present invention is illustrated with the manufacturing of a vamp 10. First, a TPU raw material and an assistant are put in a mixer, wherein the assistant provides lubrication and comes in the form of graphite or sulfur. Then, the mixture of the TPU raw material and the assistant is heated up to turn into a pellet-shaped first raw material.
2. Afterward, the pellet-shaped first raw material undergoes roller mixing to get mixed fully and cooled, thereby forming a plastic sheet product.
3. The plastic sheet product is put in a coater such that the plastic sheet product stretches and does not wrinkle or bend. Then, the plastic sheet product undergoes a foaming process and thus expands. Afterward, the plastic sheet product is processed with ultraviolet (UV) to keep its temperature stable.
4. The foaming plastic sheet product is put in a vacuum embossing roll so as to be embossed and thus provided with the vamp 10, a pattern 11, and a texture 12. In this step, the vacuum embossing roll has the texture 12 which looks like sewing stitches. After the foaming plastic sheet product has been wound into the vacuum embossing roll, it undergoes evacuation so as for the foaming plastic sheet product to acquire the texture 12 which looks like sewing stitches or even vamp decorations, and then it is wound into a cylinder.
5. A processing worker cuts the foaming plastic sheet which has the pattern and texture to obtain the integrally-formed nonwoven object. After this step, the processing worker performs screen printing or digital printing on the integrally-formed nonwoven object as needed, so as to render the vamp 10 colorful.
6. In the raw material mixing step, a dye is introduced into the assistant to render the first raw material colorful. If the nonwoven object is solid-colored, the screen printing step and the digital printing step can be dispensed with.
7. The processing process of the present invention is carried out in an all-in-one manner and thus dispenses with any affixation operation. Unlike its conventional counterpart, the nonwoven object of the present invention need not be cut, sewn and affixed with decorations, thereby simplifying the processing process.
8. In addition to vamps, the present invention is applicable to sofas, car seats, car dashboards, leather wallets and others, and sports equipment.

The present invention is disclosed above by preferred embodiments. However, persons skilled in the art should understand that the preferred embodiments are illustrative of the present invention only, but should not be interpreted as restrictive of the scope of the present invention. Hence, all equivalent changes made to the aforesaid embodiments should fall within the scope of the present invention.

What is claimed is:

1. An integrally-formed nonwoven object manufacturing method, comprising:
a raw material mixing step in which TPU resin particles and an assistant are put in a mixer to get mixed while being heated up, thereby allowing the TPU resin particles and the assistant to melt and turn into a pellet-shaped first raw material;
a roller mixing step in which the first raw material is placed between rollers to get rolled and heated up such that the first raw material is fully mixed, thereby allowing the rolled first raw material to turn into a semi-liquefied second raw material;
a plastic sheet forming step in which the second raw material is put in a plastic sheet-forming machine, wherein a distance between rollers of the plastic sheet-forming machine is controlled to therefore control a thickness of a doughy plastic sheet product, and the plastic sheet product passes a cooling roller to get cooled and shaped before being wound onto a shaft;
a foaming step in which the wound plastic sheet product is placed on a coater and delivered into a foaming furnace to get heated to 200° C. such that it foams and expands, and then the plastic sheet product which has foamed is processed with ultraviolet (UV) to keep its temperature stable;
an embossing step in which the UV-processed foaming plastic sheet product is placed beneath a vacuum embossing roll with a concave pattern and texture and wound into the vacuum embossing roll to produce a foaming plastic sheet with the pattern and texture formed thereon by evacuation, and then the foaming plastic sheet is cooled and wound into a cylinder; and
a post-process step in which the foaming plastic sheet with the pattern and texture is cut to obtain the integrally-formed nonwoven object.

2. The integrally-formed nonwoven object manufacturing method of claim 1, further comprising a screen printing step in which the integrally-formed nonwoven object is fitted onto a screen and coated with colors and textures such that the nonwoven object acquires different colors and textures.

3. The integrally-formed nonwoven object manufacturing method of claim 1, further comprising a digital printing step in which the integrally-formed nonwoven object is placed on a digital printer and coated with colors and textures such that the nonwoven object acquires different colors and textures.

4. The integrally-formed nonwoven object manufacturing method of claim 1, wherein, in the raw material mixing step, a dye is introduced into the assistant to render the first raw material colorful.
